(19) United States
(12) Patent Application Publication
(10) Pub. No.: US 2010/0014156 A1
(43) Pub. Date: Jan. 21, 2010

(54) MICROSCOPE

(76) Inventor: Yoshinori Iketaki, Oume-shi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/438,994

(22) PCT Filed: Aug. 8, 2007
(86) PCT No.: PCT/JP2007/065539

§ 371 Date: Feb. 26, 2009

(30) Foreign Application Priority Data
Aug. 29, 2006 (JP) 2006-232115

(51) Int. Cl. G02B 21/06

(52) U.S. Cl. 359/385

(57) ABSTRACT

A microscope for observing a sample containing a substance having at least two excited quantum states includes a pump light source 21 for emitting pump light, an erase light source 22 for emitting erase light, a light combining section 23 to 26 for coaxially combining the pump light and the erase light, a light collecting section 62 for collecting the combined lights, a scanning section 44 and 45 for scanning the sample with the combined lights, a detecting section 50 for detecting photoresponsive signals generated from the sample, a wavelength selecting element 42 arranged in the light path of the combined lights and provided with an erase light selecting region having a high wavelength selectivity for the erase light and with a pump light selecting region having a high wavelength selectivity for the pump light, and a space modulating element 43 arranged in the light path of the combined lights for spatially modulating the erase light corresponding to the erase light selecting region of the wavelength selecting element.

### CROSS-REFERENCE OF RELATED APPLICATION

The present application is claiming the priority based on the Japanese Patent Application No. 2006-232,115 filed on Aug. 29, 2006. The whole disclosure of the original application is incorporated herein for reference.

### TECHNICAL FIELD

This invention relates to a microscope, and more particularly to a highly efficient and highly functional super-resolving microscope enabling a high spatial-resolution by irradiating a stained sample with lights of wavelengths from laser sources of high functionality.

### BACKGROUND ART

The technique of optical microscopes has an old history during which various types of microscopes have been developed. In recent years, moreover, as peripheral technologies such as laser technology and electronic imaging technology have been advanced, even higher-performance microscopic systems have been developed.

In such a background, high-performance microscopes have been proposed which use the double resonance absorption process generated by illuminating a sample with lights of a plurality of wavelengths to enable controlling of contrast of obtained images and chemical analyses as well, for example, in Japanese Patent Application Laid Open No. H08-184,552.

With such microscopes, the double resonance absorption is used to select particular molecules to observe absorption and fluorescence caused by particular optical transition. This principle will be explained with reference to FIGS. 10 to 13. FIG. 10 illustrates electron structures of valence orbits of molecules constituting a sample. First, the electrons of the valence orbits of the molecules in the ground state (state S0) shown in FIG. 10 are excited by a light of wavelength λ1 to be changed to a first electronically-excited state (State S1) shown in FIG. 11. Then, the molecules are excited by the other light of wavelength λ2 in the similar manner to be changed to a second electronically excited state (state S2) shown in FIG. 12. The molecules in this excited state generate fluorescence or phosphorescence to be returned to the ground state as shown in FIG. 13.

In the microscopy using the double resonance absorption process, absorption images and luminescent images are observed using the absorption process in FIG. 12 and the emissions of fluorescence and phosphorescence in FIG. 13. In this microscopy, at the beginning the molecules constituting the sample are excited with the light of resonant wavelength λ1 by means of laser beams or the like to the state S1 as in FIG. 11. In this case, the number of molecules in the state S1 in a unit volume increases as the irradiated light intensity increases.

At this point, as the linear absorption coefficient is obtained by product of the absorption cross-section per one molecule and the number of molecules per unit volume, the linear absorption coefficient regarding the resonant wavelength λ2 subsequently irradiated depends on the intensity of the light of wavelength λ1 initially irradiated in the excitation process as shown in FIG. 12. In other words, the linear absorption coefficient regarding the wavelength λ2 can be controlled by the intensity of the light of wavelength λ1. This indicates that a sample is irradiated with the lights of different wavelengths λ1 and λ2, and the transmission image generated by the wavelength λ2 is photographed, thereby enabling the contrast of the transmission image to be completely controlled by means of the light of the wavelength λ1.

In the case that the deexcitation process by the fluorescence or phosphorescence is possible in the excited state as shown in FIG. 12, its emission intensity is proportional to the number of the molecules in the state S1. In the case utilizing it as a fluorescence microscope, therefore, it is also possible to control the image contrast.

In the microscopy using the double resonance absorption process, moreover, it becomes possible not only to control the image contrast as described above but also to perform the chemical analysis. In other words, as the outermost shell electron orbits shown in FIG. 10 have energy levels inherent in the respective molecules, the wavelength λ1 is different from each individual molecule, and at the same time, the wavelength λ2 is also inherent in each of the molecules.

At this moment, even with the illumination of single wavelength of the prior art, to some extent it is possible to observe absorption images or fluorescent images of particular molecules, but it is impossible to accurately identify the chemical compositions of the sample, because regions of wavelengths of absorption bands in some molecules are generally overlapped.

In contrast herewith, with the microscopy using the double resonance absorption process, it becomes possible to more accurately identify chemical compositions, because molecules which absorb or emit light are limited with two wavelengths of λ1 and λ2, in comparison with the prior art methods. In case that valency electrons are excited, moreover, as only lights having particular electric field vectors with respect to molecular axes are strongly absorbed, after polarization directions of the wavelengths λ1 and λ2 are determined, by photographing absorption images or fluorescent images it becomes possible to identify directions of orientation even for the same molecules.

In recent years, further, a fluorescence microscope has been proposed which has a high spatial resolution exceeding the diffraction limit using double resonance absorption process, for example, in Japanese Patent Application Laid Open No. 2001-100,102.

FIG. 14 is a conceptual diagram of the double resonance absorption process in molecules, which shows an aspect that molecules in the ground state S0 are excited by the light of wavelength λ1 to the first electronically excited state S1, and further excited by the second light of wavelength λ2 to the second electronically excited state S2. Moreover, FIG. 14 illustrates that the fluorescence from some kinds of molecules in the second electronically excited state S2 is extremely weak.

In the case of the molecules having an optical property as shown in FIG. 14, a very interesting phenomenon occurs. FIG. 15 is a conceptual diagram of the double resonance absorption process like FIG. 14. The X-axis of abscissa indicates broadening of spatial distance, and shown are space domains A1 irradiated with the light of wavelength λ2 and a space domain A0 not irradiated with the light of wavelength λ2.

In FIG. 15, a number of molecules in the state S1 are produced by excitation with the light of wavelength λ1 in the space domain A0, on that occasion fluorescence emitting light of wavelength λ3 from the space domain A0 can be seen. In the space domain A1, however, most of the molecules in the state S1 are immediately excited to the higher state S2 by irradiating with the light of wavelength λ2 so that there are no molecules in the state S1 in the space domain A1. Such a phenomenon is confirmed with several kinds of molecules. Consequently, the fluorescence of wavelength λ3 is completely eliminated in the space domain A1, and the fluorescence from the state S2 does not exist originally so that in the space domain A1, the fluorescence itself is completely restrained (fluorescence restrictive effect), with the result that the fluorescence is emitted only from the space domain A0.

This fact has important implications from a viewpoint of application fields of the microscope. In other words, with the prior art scanning laser microscopes and the like, laser beams are focused by collecting lens into microbeams by means of which a sample is scanned, on that occasion the size of the microbeams provides a limitation of diffraction determined by numerical apertures of the collecting lens and wavelength so that any more spatial resolution cannot be essentially expected.

In contrast herewith, in the case of FIG. 15, two kinds of lights of wavelength λ1 and λ2 are spatially overlapped suitably to restrain the fluorescence regions by irradiating the light of wavelength λ2 so that upon noticing the region irradiated with, for example, the light of wavelength λ1, the fluorescence regions can be scaled down to be smaller than the limitation of diffraction determined by numerical apertures of the collecting lens and wavelength, thereby enabling the spatial resolution to be substantially improved. The light of wavelength λ1 is called “pump light” and the light of wavelength λ2 is called “erase light” in addition to their original names hereinafter. By utilizing this principle, therefore, it becomes possible to realize a super-resolution microscope, for example, a super-resolution fluorescence microscope using the double resonance absorption process exceeding the diffraction limit.

In the case of a sample stained with rhodamine 6G pigment, for example, when the sample is irradiated with light (pump light) of wavelength of 532 nm, the rhodamine 6G molecules are excited from the S0 state to the S1 state to emit fluorescence having a peak value at wavelength of 560 nm. In this case, upon irradiation of 599 nm wavelength light (erase light), a double resonance absorption process is caused so that the rhodamine 6G molecules transit to the S2 state in which the fluorescent emission is difficult. In other words, if the rhodamine 6G is irradiated with these pump light and erase light at a time, the fluorescence is suppressed.

FIG. 16 is a block diagram of main parts of the optical system of a super-resolving microscope hitherto proposed. This super-resolving microscope is based on the premise of the typical laser scanning fluorescence microscope and mainly comprises three independent units, that is, a light source unit 110, a scan unit 130, and a microscope unit 150.

In the light source unit 110, the pump light emitted from a pump light source 111 is fed into dichroic prisms 114, while the erase light emitted from an erase light source 112 is passed through a phase plate 113 where phase modulation of the erase light is performed and thereafter the phase-modulated erase light is fed into the dichroic prisms 114 where the pump light and the erase light are combined with each other and the combined pump and erase lights are coaxially emitted.

The phase plate 113 is so constructed that phase differences of the erase light vary by 2π around the optical axis. As shown in FIG. 17, for example, a glass substrate is so etched that there are eight independent regions about an optical axis, whose phases are different from one another by ⅛ with respect to wavelength of the erase light. FIG. 17 also shows depths d of etching in the respective regions. The lights passed through the phase plate 113 are collected to obtain a hollow-shaped erase light in which electric fields are cancelled out on the optical axis.

In the case that a sample stained with rhodamine 6G pigment is observed, the pump light source 111 is constructed using an Nd:YAG laser so as to be able to emit 532 nm wavelength light as a pump light which is second harmonic waves of the Nd:YAG laser. The erase light source 112 is constructed using an Nd:YAG laser and a Raman shifter so that the second harmonic waves of the Nd:YAG laser are converted by the Raman shifter to 599 nm wavelength light which is emitted as the erase light.

In the scan unit 130, the pump light and the erase light coaxially emitted from the light source unit 110 pass through half prisms 131 and thereafter oscillated and scanned in two dimensional directions by two galvano mirrors 132 and 133, and emitted onto the microscope unit 150 later described. Further, the fluorescence detected in the microscope unit 150 propagates through the same pathway in the reverse direction toward the half prisms 131 where the arrived fluorescence diverges. The diverged fluorescence is received in a photoelectron multiplier 138 through a projection lens 134, a pinhole 135, and notch filters 136 and 137.

In FIG. 16, the galvano mirrors 132 and 133 are shown in a manner that as if they were able to oscillate or rock in the same plane for the sake of simplicity. In addition, the notch filters 136 and 137 serve to remove the pump and erase lights mixed in the fluorescence. Moreover, the pinhole 135 is an important optical element constituting a confocal optical system and serves to permit only the fluorescence emitted at a specified cross-section in a sample to pass therethrough.

The microscope unit 150 is a so-called fluorescence microscope typically used and operates in a manner that the pump and erase lights incident from the scan unit 130 are reflected at half prisms 151 and focused through a microscope objective lens 152 on the sample 153 containing molecules having three electronic states including at least a ground state. Further, the fluorescence emitted at the sample 153 to be observed is collimated at the microscope objective lens 152 again and reflected at the half prisms 151 so as to be returned into the scan unit 130, and at the same time part of the fluorescence passing through the half prisms 151 is conducted to an eyepiece 154 so that the fluorescence can be visually observed as fluorescent image.

According to this super-resolving microscope, the fluorescence at the light-collected point on the sample 153 to be observed is suppressed except for the fluorescence in the proximity of the optical axis where the intensity of the erase light becomes zero, with the result that only the fluorescence labeler molecules can be measured which exist in a region smaller than the broadening of the pump light. Therefore, if fluorescent signals at respective measurement points are two dimensionally arranged in a computer, it becomes possible to form microscopic images with a resolution exceeding the spatial resolution of diffraction limit.

According to the experimental investigation of the inventors of the present application, however, the super-resolving microscope hitherto proposed have problems described below to be solved, particularly in performance of image formation and assembling of microscopes.

In other words, with the super-resolving microscope it is necessary to make the light paths of the pump and erase lights completely coaxially coincide with each other so that the peak position of the pump light must completely coincide with the central hollow portion of the erase light on the focal plane.

In the super-resolving microscope shown in FIG. 15, however, after the phase modulation of the erase light by means of the phase plate 113 has been effected, the phase-modulated erase light is fed into the dichroic prisms 114 in which the erase light is combined with the pump light incident through the light path completely independent from the light path of the erase light. Therefore, it is difficult to optically adjust the positions of the pump light source 111, the erase light source 112, the phase plate 113, and the dichroic prisms 114 so that the pump light and the phase-modulated erase light to completely coaxially coincide with each other.

Consequently, the peak position of the pump light would shift toward the periphery of the erase light on the focal plane so that the fluorescence in the whole focused region of the pump light is suppressed, thereby worryingly causing deterioration of resolution and S/N ratio.

### DISCLOSURE OF THE INVENTION

Therefore, the invention achieved in view of such circumstances has an object to provide a microscope enabling the optical adjustment of the pump and erase lights to be simply and accurately performed to realize a super-resolution effect with great certainty.

The first aspect of the invention, which achieves the object described above, is a microscope for observing a sample containing a substance having at least two excited quantum states, said microscope comprising:

a pump light source for emitting pump light for exciting said substance from its ground state to a first excited state,
an erase light source for emitting erase light for making said substance transit from said first excited state to another excited state,
light combining means for coaxially combining said pump light and said erase light,
light collecting means for collecting the combined lights combined by said light combining means onto said sample,
scanning means for scanning said sample with said combined lights by relatively moving said sample and said combined lights collected by said light collecting means,
detecting means for detecting photoresponsive signals generated from said sample by irradiating with said combined lights,
a wavelength selecting element arranged in a light path of said combined lights and including an erase light selecting region having a high wavelength selectivity for said erase light and a pump light selecting region having a high wavelength selectivity for said pump light, and
a space modulating element arranged in the light path of said combined lights for spatially modulating the erase light corresponding to said erase light selecting region of said wavelength selecting element.

The second aspect of the invention resides in the microscope according to the first aspect, wherein said wavelength selecting element comprises a spectral transmission filter having an erase light selecting region of a high transmittance for said erase light and a pump light selecting region of a high transmittance for said pump light.

The third aspect of the invention resides in the microscope according to the first aspect, wherein said wavelength selecting element comprises a reflecting mirror having an erase light selecting region made of multilayer films of a high reflectance factor for said erase light and a pump light selecting region made of multilayer films of a high reflectance factor for said pump light.

The forth aspect of the invention resides in the microscope according to the first aspect, wherein said wavelength selecting element comprises a diffraction grating having an erase light selecting region of a high diffraction efficiency for said erase light and a pump light selecting region of a high diffraction efficiency for said pump light.

The fifth aspect of the invention resides in the microscope according to the second aspect, wherein said wavelength selecting element is so formed that said combined lights passed through said wavelength selecting element have in the cross-section of optical axis an erase light region where only an intensity of said erase light exists, a pump light region where only an intensity of said pump light exists, and an overlapping region located at the border between said erase light region and said pump light region, said overlapping region being smaller than the contour of said combined lights in the cross-section of the optical axis and having a low overlapping intensity of said erase light and said pump light.

The sixth aspect of the invention resides in the microscope according to the third aspect, wherein said wavelength selecting element is so formed that said combined lights passed through said wavelength selecting element have in the cross-section of optical axis an erase light region where only an intensity of said erase light exists, a pump light region where only an intensity of said pump light exists, and an overlapping region located at the border between said erase light region and said pump light region, said overlapping region being smaller than the contour of said combined lights in the cross-section of the optical axis and having a low overlapping intensity of said erase light and said pump light.

The seventh aspect of the invention resides in the microscope according to the first aspect, wherein said wavelength selecting element has said erase light selecting region and said pump light selecting region divided in the form of concentric circles.

The eighth aspect of the invention resides in the microscope according to the second aspect, wherein said wavelength selecting element has said erase light selecting region and said pump light selecting region divided in the form of concentric circles.

The ninth aspect of the invention resides in the microscope according to the third aspect, wherein said wavelength selecting element has said erase light selecting region and said pump light selecting region divided in the form of concentric circles.

The tenth aspect of the invention resides in the microscope according to the seventh aspect, wherein said pump light selecting region of said wavelength selecting element occupies a circular region in the proximity of the optical axis, and said erase light selecting region of said wavelength selecting element occupies an annular zone region on the outer side of said pump light selecting region.

The eleventh aspect of the invention resides in the microscope according to the eighth aspect, wherein said pump light selecting region of said wavelength selecting element occupies a circular region in the proximity of the optical axis, and said erase light selecting region of said wavelength selecting element occupies an annular zone region on the outer side of said pump light selecting region.

The twelfth aspect of the invention resides in the microscope according to the ninth aspect, wherein said pump light selecting region of said wavelength selecting element occupies a circular region in the proximity of the optical axis, and said erase light selecting region of said wavelength selecting element occupies an annular zone region on the outer side of said pump light selecting region.

The thirteenth aspect of the invention resides in the microscope according to the tenth aspect, wherein the diameter of said pump light selecting region of said wavelength selecting element is smaller than the diameter of an incident aperture of said light collecting means, and the outer diameter of said erase light selecting region of said wavelength selecting element is larger than the diameter of the incident aperture of said light collecting means.

The fourteenth aspect of the invention resides in the microscope according to the eleventh aspect, wherein the diameter of said pump light selecting region of said wavelength selecting element is smaller than the diameter of an incident aperture of said light collecting means, and the outer diameter of said erase light selecting region of said wavelength selecting element is larger than the diameter of the incident aperture of said light collecting means.

The fifteenth aspect of the invention resides in the microscope according to the twelfth aspect, wherein the diameter of said pump light selecting region of said wavelength selecting element is smaller than the diameter of an incident aperture of said light collecting means, and the outer diameter of said erase light selecting region of said wavelength selecting element is larger than the diameter of the incident aperture of said light collecting means.

The sixteenth aspect of the invention resides in the microscope according to the tenth aspect, wherein said space modulating element comprises a phase plate having a substrate transparent to said pump light and said erase light and having an etched region for phase-modulating the erase light corresponding to said erase light selecting region of said wavelength selecting element.

The seventeenth aspect of the invention resides in the microscope according to the eleventh aspect, wherein said space modulating element comprises a phase plate having a substrate transparent to said pump light and said erase light and having an etched region for phase-modulating the erase light corresponding to said erase light selecting region of said wavelength selecting element.

The eighteenth aspect of the invention resides in the microscope according to the twelfth aspect, wherein said space modulating element comprises a phase plate having a substrate transparent to said pump light and said erase light and having an etched region for phase-modulating the erase light corresponding to said erase light selecting region of said wavelength selecting element.

The nineteenth aspect of the invention resides in the microscope according to the tenth aspect, wherein said space modulating element comprises a phase plate having a substrate transparent to said pump light and said erase light and coated with an optical film for phase-modulating the erase light corresponding to said erase light selecting region of said wavelength selecting element.

The twentieth aspect of the invention resides in the microscope according to the eleventh aspect, wherein said space modulating element comprises a phase plate having a substrate transparent to said pump light and said erase light and coated with an optical film for phase-modulating the erase light corresponding to said erase light selecting region of said wavelength selecting element.

The twenty-first aspect of the invention resides in the microscope according to the twelfth aspect, wherein said space modulating element comprises a phase plate having a substrate transparent to said pump light and said erase light and coated with an optical film for phase-modulating the erase light corresponding to said erase light selecting region of said wavelength selecting element.

The twenty-second aspect of the invention resides in the microscope according to the first aspect, wherein said wavelength selecting element and/or said space modulating element is provided in the lens barrel of said light collecting means.

The twenty-third aspect of the invention resides in the microscope according to the first aspect, wherein said wavelength selecting element and/or said space modulating element is provided in a pupil surface, or a conjugate pupil surface of said light collecting means, or in the proximity thereof.

First, the outline of the present invention will be explained. The basic idea of the invention to solve the tasks described above lies in an achievement of positional alignment with a mechanical accuracy between the pump light and the erase light, which was the most difficult problem in assembling a super-resolving microscope, whereby the adjustment operation for optical axes of respective beams becomes unnecessary.

For this purpose, the pump light and the erase light are combined by simultaneously emitting these lights through a fine exit opening such as a pinhole. In particular, the pump light and the erase light are emitted at a time to a single mode fiber or the like so that these lights are emitted with the same solid angle through the same exit opening. The thus combined pump and erase lights are caused to provide images using an achromatic optical system having no color aberration, thereby completely coaxially collimating and collecting the pump light and the erase light. In particular, by collecting these lights by means of a microscope objective lens, the pump light and the erase light can be collected or focused exactly at the same point on a focal plane.

According to one embodiment of the invention, the combined pump and erase lights adjusted to be coaxial and to have same diameter are emitted into a wavelength-selecting element. The wavelength-selecting element is made from, for example, an annular zone filter 1 as shown in FIG. 1. The annular zone filter 1 is of a concentric circular structure, and has at its center an inner circular region of an inner radius rᵢₙ which is a pump light selecting region 1a having a spectral characteristic which exhibits a high transmittance for the pump light but a low transmittance for the erase light. Further, the annular zone filter 1 has an annular zone region between the outer or pupil radius rₒᵤₜ and the inner radius rᵢₙ, which is an erase light selecting region 1b having a spectral characteristic which exhibits a high transmittance for the erase light but a low transmittance for the lamp light.

When the pump and erase lights adjusted to be coaxial and to have the same diameters are emitted into the annular zone filter 1 the circular pump light selecting region 1a of the annular zone filter 1 mainly permits the pump light to transmit therethrough and the annular erase light selecting region 1b mainly permits the erase light to transmit therethrough.

Further, as the space modulating element for producing the hollow-shaped erase light, an annular zone phase plate 2, for example, as shown in FIG. 2 is used. The annular zone phase plate 2 comprises a substrate made of glass and has at its center a circular region of an inner radius rᵢₙ, which is a phase unmodulating region 2a permitting an incident light to transmit without modulating its phase. Further, the annular zone phase plate 2 has an annular zone region between the outer radius rₒᵤₜ and the inner radius rᵢₙ, which is a phase modulating region 2b etched to form eight regions about an optical axis, whose phases are different from one another by ⅛ with respect to the wavelength of the erase light in a manner that phase differences of the erase light vary by 2 π around a 360-degree.

The shapes of the annular zone filter 1 shown in FIG. 1 and of the annular zone phase plate 2 shown in FIG. 2 are formed to completely coincide with each other by forming the same inner radii and the same outer radii, respectively. These annular zone filter 1 and annular zone phase plate 2 are coaxially arranged, and the pump light and the erase light optically coaxially adjusted are transmitted through the coaxially arranged annular filter 1 and phase plate 2, thereby obtaining a phase-modulated erase light region 5a having an intensity distribution in the annular zone and a pump light region 5b which passes inside the erase light region 5a and is not subjected to phase modulation as shown in FIG. 3 illustrating a section of beams. Moreover, after passing through the annular zone filter 1, the combined pump and erase lights may be emitted through the annular zone phase plate 2, or inversely, after passing through the annular zone phase plate 2, the combined lights may be emitted through the annular zone filter 1.

Therefore, if the pump light and the erase light having the beam section shown in FIG. 3 are collected or focused with the same microscope objective lens, the erase light is collected in the hollow shape on an imaging surface and the pump light is collected in a Rayleigh's circular diffraction pattern. At this time, if the pump light and the erase light are completely coaxial, the center of the hollow erase light completely coincides with the peak position of the pump light on the imaging surface as shown in FIG. 4 illustrating a light collection pattern.

For example, if the pump light and the erase light coaxially adjusted are conducted through the same exit opening of a single mode fiber as described above and pass through the same optical system without both the lights being delivered, the pump light and the erase light do not have a wave aberration and are collected exactly at the same imaging location with the same divergence (broadening of beams). Accordingly, if the optical system is constructed in this manner, the optical adjustment of the system is not required.

Concerning the pump light, in the case using the annular zone filter 1 shown in FIG. 1, the periphery of the pupil surface is cut by the annular zone filter 1. For this reason, the numerical aperture (NA) of the microscope objective lens is substantially reduced depending on the area ratio of light interception. In the case of the annular zone filter 1 shown in FIG. 1, for example, the diameter or full width (Rp) of light collection spot of the pump light is determined by the ratio of the outer diameter or pupil diameter (rₒᵤₜ) of the erase light selecting region 1b to the diameter (rᵢₙ) of the erase light interception region through which the pump light is transmitted. Specifically, when the wavelength of the pump light is λp, Rp is determined by the following equation (1) according to the Rayleigh's formula.

$$Rp = 1.22 \frac{λ p}{\frac{r in}{r out} NA} \qquad ( 1 )$$

Assuming that rᵢₙ/rₒᵤₜ is, for example, 70%, the full width Rp of the light collection spot obtained from the formula (1) is about 30% larger than that in the case using the full pupil diameter.

As the light collection pattern shown in FIG. 4, however, when the diameter of the pump light is smaller than the outer diameter of the erase light, the image formation performance of a super-resolving microscope, or the half bandwidth of point image distribution function is determined depending upon the intensity of the erase light and the light collection pattern. At this moment, if the wavelength of the erase light is λe, the diameter (Re) of the outer ring at the light collection spot of the erase light is indicated by 2λe/NA. Therefore, if the diameter Rp of the light collection spot of the pump light passed through the inside of the annular zone filter is smaller than Re, the portion irradiated with the pump light on the imaging surface except for the proximity of the optical axis is completely covered with the region irradiated with the erase light.

Specifically, a condition indicated by a formula (2) described below is obtained from the formula (1). As λp is 532 nm and λe is 599 nm in the case of rhodamine 6G molecules, this condition is fulfilled when rᵢₙ/rₒᵤₜ is 70%. In the formula (2), moreover, “rp” indicates the radius (Rp/2) of the light collection spot of the pump light, while “re” indicates the radius (Re/2) of the light collection spot of the erase light.

$$0.61 \frac{λ p}{λ e} \leq \frac{r p}{r e} \qquad ( 2 )$$

Under such a condition, the image formation performance of the super-resolving microscope is determined by the intensity of the erase light and the optical physicality of pigment molecules irrespective of the light collection state of the pump light. In other words, the half bandwidth (Γ) of the point image distribution function is represented by the formula (3) described below and is smaller than the limit size for diffraction of the pump light. In the formula (3), moreover, “Ie” denotes the maximum photon flux of the erase light at the light collection surface, and “σ dip” and “τ” indicate the fluorescence suppression cross-sectional area of pigment molecules and fluorescence lifetime, respectively.

$$Γ = 0.49 \sqrt{\frac{1}{τ σ dip I e}} \frac{λ e}{NA} \qquad ( 3 )$$

At this point, the fluorescence suppression cross-sectional area σ dip is an optical constant defined in a document: Y. Iketaki, T. Watanabe, M. Sakai, S. Ishiuchi, M. Fujii and T. Watanabe, “Theoretical investigation of the point-spread function given by super-resolving fluorescence microscopy using two-color fluorescence dip spectroscopy”, Opt. Eng. 44, 033602 (2005), and is represented by σ dip=σf+ασup, where σf is cross-section of stimulated emission, and σup is double resonance absorption cross-section when transiting from S1 state to Sn state (n: positive integer of two or more), and α is probability of relaxation from Sn state under nonradiation.

Therefore, even if after the pump light and the erase light are coaxially adjusted by the single mode fiber, the coaxially adjusted pump and erase lights are caused to pass through the annular zone filter and annular zone phase plate to perform the phase modulation of the erase light, the image formation performance is not degraded in comparison with the prior art methods. In addition, complicated individual optical adjustments for the pump light and the erase light as is the case with the prior art is not required according to the invention.

Moreover, as the wavelength selecting element, the annular zone filter 11 as shown in FIG. 5 may be used. The annular zone filter 11 is so constructed that the pump light selecting region 11a and the erase light selecting region 11b are arranged in an inverse manner of the arrangement of the pump light selecting region 1a and the erase light selecting region 1b of the annular zone filter 1 shown in FIG. 1 so that the circular region of inner radius rᵢₙ at the center is an erase light selecting region 11b having a high transmittance for the erase light but a low transmittance for the pump light, and the annular zone region between the pupil radius or outer radius rₒᵤₜ and the inner radius rᵢₙ is a pump light selecting region 11a having a high transmittance for the pump light but a low transmittance for the erase light.

Similarly, as the space modulating element, for example, the annular zone phase plate 12 as shown in FIG. 6 may be used. The annular zone phase plate 12 is so constructed that the phase unmodulating region 12a and the phase modulating region 12b are arranged in an inverse manner of the arrangement of the phase unmodulating region 2a and the phase modulating region 2b of the annular zone phase plate 2 shown in FIG. 2 so that the circular region of the inner radius rᵢₙ at the center is a phase modulating region 12b etched to form eight regions about the optical axis, whose phases are different from one another by ⅛ with respect to the wavelength of the erase light in a manner that phase differences of the erase light vary by 2π around the optical axis, and the annular zone region between the outer radius rₒᵤₜ and the inner radius rᵢₙ is a phase unmodulating region 12a which permits an incident light to transmit without modulating its phase.

When using the annular zone filter 11 and the annular zone phase plate 12 shown in FIGS. 5 and 6, the NA of the microscope objective lens with respect to the erase light becomes smaller effectively. Consequently, the diameter of the hollow portion at center of the erase light becomes larger so that the fluorescence suppression effect at the periphery of the pump light becomes weak. However, when the intensity of the erase light is increased, the super-resolving effect can be realized according to the formula (3).

The invention can be particularly easily applicable to commercially available laser scanning type microscopes for carrying out spatial scanning by laser beams using the galvano mirror by coaxially emitting the laser beams of multiple wavelengths from one single mode fiber. In other words, laser sources corresponding to the wavelengths of the erase light and pump light are prepared, and the pump light and the erase light emitted from these laser sources through a single mode fiber are collimated and thereafter the collimated pump and erase lights are caused to pass through the wavelength selecting element and the space modulating element described above, thereby enabling the super-resolving function to be readily added to the commercially available laser scanning type microscopes.

In the present invention, moreover, it is preferable to use the optical fiber as the light combining means for combining the pump light and the erase light. Even with the case using a usual dichroic mirror or the like for coaxially adjusting the pump light and the erase light, the convenience in optical adjustment can be improved. In this case, although the operation for coaxially adjusting the pump light and the erase light is required as is the case with the prior art, the coaxially adjusted pump and erase lights are induced into the wavelength selecting element and the space modulating element as described above, so that the pump light and the erase light result in being subjected to the influence of exactly the same divergence and angular deviance by means of these optical elements.

In this case, the absolute positions of collected points of the pump light and the erase light in the space are varied by adjusting, but relative positional relations of the collected points are not varied. In other words, the pump light and the erase light are collected at the same positions. Therefore, for example, if the pump light and the erase light passed through the wavelength selecting element and the space modulating element are scanned by means of positional adjustment of the microscope sample stage and the galvano mirror as optical scanning means, the image formation performance can be restored.

Moreover, the wavelength-selecting element is not to be limited to the annular zone filter of the transmission type. A reflecting mirror may be used which is coated with multilayer films which form a pump light selecting region for reflecting mainly the pump light and an erase light selecting region for reflecting mainly the erase light, and the pump light and the erase light reflected at the reflecting mirror may be used. Or a diffraction grating may be used which has a plump light selecting region for diffracting mainly the pump light and an erase light selecting region for diffracting mainly erase light, and the pump light and the erase light diffracted at the diffraction grating may be used.

Similarly, the space-modulating element is not to be limited to the phase plate formed by etching an optical substrate transparent to the pump light and the erase light. A phase plate formed of an optical substrate coated with optical films may be used. Or the space-modulating element may be constructed using a liquid crystal optical spatial modulator, a deformable mirror which is variable in shape, or the like.

Moreover, the space modulating element and the wavelength-selecting element may be provided in a lens barrel of the microscope objective lens. If employing such a construction, by exchanging a microscope objective lens only, a super-resolving function can be given to a commercially available laser scanning type microscopy system without modifying its configuration, thereby improving its convenience.

Particularly, if the space modulating element and the wavelength selecting element are arranged at the pupil position of the microscope objective lens, there is less wave aberration even when the pump light and the erase light are spatially scanned so that the high image formation performance can be held with a wide field of view particularly without disturbing the light collection shapes of the erase light which might exert an influence on the super-resolving microscope faculty.

Moreover, the super-resolving microscope according to the invention is widely applicable to the observation of illuminant materials exhibiting the fluorescence suppression effect, For example, the invention is applicable to observations of samples of fluorescent molecules consisting of organic dye molecules such as rhodamine 6G realizing the fluorescence suppression effect having two or more excited quantum states, semiconductor quantum dots such as Csd or ZnO, fluorescent complex molecules such as tri (8-quinolinol) aluminum, fluorescence protein exhibiting the photochromic characteristics such as FP595GFP, and the like.

### BRIEF DESCRIPTION OF THE DRAWINGS

FIG. 1 is a view illustrating one example of the wavelength-selecting element constituting the microscope according to the invention;

FIG. 2 is a view illustrating one example of the space-modulating element constituting the microscope according to the invention;

FIG. 3 is a view illustrating a beam section of the combined lights after having passed through the annular zone filter shown in FIG. 1 and the annular zone phase plate shown in FIG. 2;

FIG. 4 is a view illustrating a light collection pattern at an image formation surface of the pump light and erase light having beam cross-sections shown in FIG. 3;

FIG. 5 is a view showing another example of the wavelength-selecting element constituting the microscope according to the invention;

FIG. 6 is a view showing another example of the space-modulating element;

FIG. 7 is a block diagram of main parts of the optical system of the super-resolving microscope according to the first embodiment of the invention;

FIG. 8 is a block diagram of main parts the optical system of the super-resolving microscope according to the second embodiment of the invention;

FIG. 9 is a block diagram of main parts the optical system of the super-resolving microscope according to the third embodiment of the invention;

FIG. 10 is a conceptual diagram illustrating an electron structure of valence orbits of molecules constituting a sample;

FIG. 11 is a conceptual diagram illustrating first excited state of molecules in FIG. 16;

FIG. 12 is a conceptual diagram illustrating second excited state of the molecules;

FIG. 13 is a conceptual diagram illustrating a state returning from the second excited state to the ground state;

FIG. 14 is a conceptual diagram for explaining double resonance absorption process of molecules;

FIG. 15 is also a conceptual diagram for explaining double resonance absorption process;

FIG. 16 is a block diagram of main parts of the optical system of the super-resolving microscope hitherto proposed; and

FIG. 17 is a view illustrating the constitution of the phase plate shown in FIG. 16.

### BEST MODE FOR CARRYING OUT THE INVENTION

Embodiments of the microscope according to the invention will be explained with reference to the drawings hereinafter.

### First Embodiment

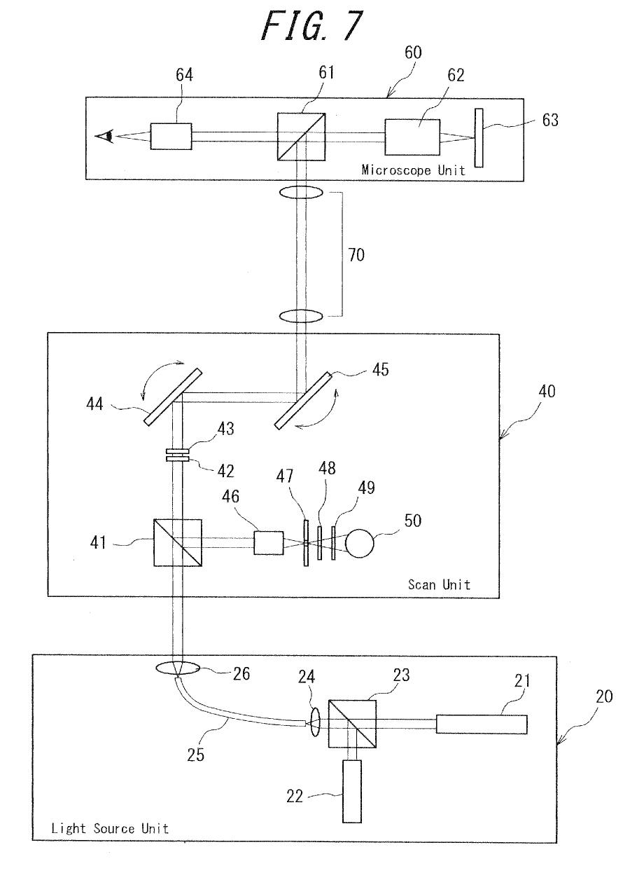

FIG. 7 is a block diagram of main parts of the optical system of the super-resolving microscope according to the first embodiment of the invention. This super-resolving microscope mainly comprises three independent units, that is, a light source unit 20, a scan unit 40, and a microscope unit 60. The scan unit 40 and the microscope unit 60 are optically combined with each other through a pupil projection lens system 70.

In the light source unit 20, pump light output from a pump light source 21 and erase light output from an erase light source 22 are combined with each other at dichroic prisms 23 and thereafter the combined lights are coaxially induced into the same single mode fiber 25 through a fiber collecting lens 24 so that the combined lights are output from the outlet opening of the single mode fiber 25 as complete spherical waves with equalized emission solid angles. The output lights are converted to plane waves at a fiber collimator lens 26 so as to be fed into the scan unit 40. At this point, the dichroic prisms 23, the fiber collecting lens 24, the single mode fiber 25 and the fiber collimator lens 26 constitute light combining means.

In the configuration of the present embodiment, in order to observe samples stained with rhodamine 6G pigment, for example, Nd:YAG laser is used as a pump light source 21 to emit 532 nm wavelength light, which is second harmonic waves of the Nd:YAG laser, as pump light, while, for example, Nd:YAG laser and a Raman shifter are used as an eraser light source 22, and second harmonic waves of the Nd:YAG laser are converted to 599 nm wavelength light by the Raman shifter, which is emitted as the erase light.

In the scan unit 40, the pump light and the erase light emitted from the light source unit 20 are caused to pass through half prisms 41 and thereafter these lights are fed through a wavelength selecting element 42 and a space modulating element 43 to two galvano mirrors 44 and 45 which are the scanning means. These lights are oscillated and scanned in two-dimensional directions by the two galvano mirrors 44 and 45 and emitted onto the microscope unit 60 (later described). Further, the fluorescence detected in the microscope unit 60 propagates through the same pathway in reverse direction toward the half prisms 41 where the arrived fluorescence diverges. The diverged fluorescence is received in a photoelectron multiplier 50 through a projection lens 46, a pinhole 47, and notch filters 48 and 49.

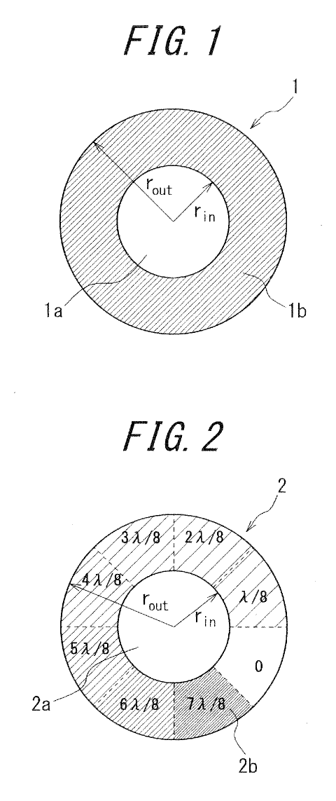

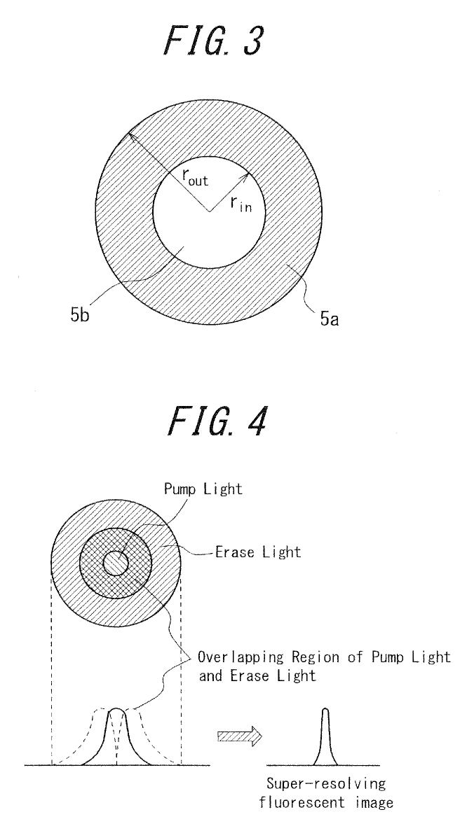

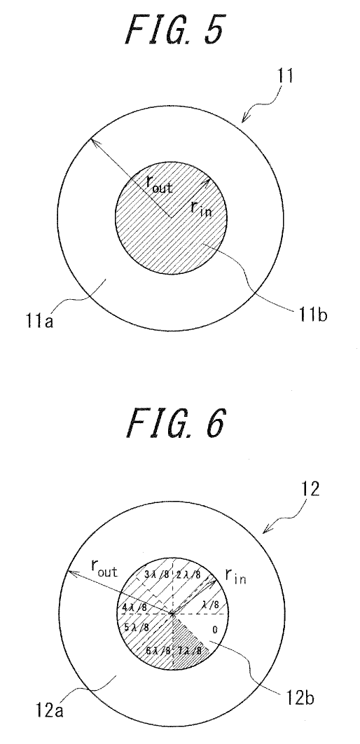

As the wavelength selecting element 42, for example, the annular zone filter 1 shown in FIG. 1 is used, while as the space modulating element 43, for example, the annular zone phase plate 2 shown in FIG. 2 is used. Moreover, the pinhole 47 serves to permit only the fluorescence emitted at a specified cross-section in a sample to pass therethrough, and the notch filters 48 and 49 serve to remove the pump and erase lights mixed in the fluorescence. Further, the galvano mirrors 44 and 45 are shown in a manner that as if they were able to oscillate or rock in the same plane for the sake of simplicity in FIG. 7.

The pump light and the erase light emitted from the scan unit 40 are conducted through the pupil projection lens system 70 into the microscope unit 60.

The microscope unit 60 is a so-called fluorescence microscope typically used and operates in a manner that the pump and erase lights incident from the scan unit 40 through the pupil projection lens system 70 are reflected at half prisms 61 and focused through a microscope objective lens 62 as the light collecting means onto the sample 63 to be observed stained with the rhodamine 6G pigment. Further the fluorescence emitted at the sample 63 is collimated at the microscope objective lens 62 and reflected at the half prisms 61 so as to be returned into the scan unit 40 through the pupil projection lens system 70. At the same time, part of the fluorescence passing through the half prisms 61 is conducted to an eyepiece 64 so that the fluorescence can be visually observed as fluorescent images. The reference numeral 62 denotes a lens barrel including the objective lens.

At this moment, the pupil projection lens system 70 serves to project the pupil position of the microscope objective lens 62 onto the inside of the scan unit 40 to form a conjugate pupil surface.

In the present embodiment, the wave length selecting element 42 and the space modulating element 43 are arranged in the conjugate surface of the microscope objective lens 62 or in the proximity thereof projected in the scan unit 40 by the pupil projection lens system 70. With such an arrangement of the two elements 42 and 43, the pump light and the erase light incident as coaxial parallel lights from the light source unit 20 are caused to pass through these elements in a manner such that by means of the wavelength selecting element 42 the pump light is mainly transmitted through the central zone and the erase light is mainly transmitted through the annular zone located at the periphery of the central zone, while by means of the space modulating element 43 the pump light at the central zone is transmitted without modulating the phase, and the erase light in the annular zone is transmitted so as to modulate the phase.

In the embodiment, in this way, in the light source unit 20, after the pump light emitted from the pump light source 21 and the erase light emitted from the erase light source 22 have been combined at the dichroic prisms 23, both the lights are emitted through the same optical system, that is, the fiber collecting lens 24 and the single mode fiber 25 without being delivered. In addition, the pump light and erase light of completely spherical waves emitted from the single mode fiber 25 are collimated under the same conditions by the fiber collimator lens 26. Without requiring any troublesome optical adjustment and without causing any wave aberration of the pump and erase lights, therefore, the pump light and erase light can be collected or condensed exactly at the same image formation points of the observation sample 63 with the same divergence (broadening of beams) by the microscope objective lens 62.

Moreover, as the wave length selecting element 42 and the space modulating element 43 are arranged in the conjugate pupil surface of the microscope objective lens 62 or in the proximity thereof projected in the scan unit 40 by the pupil projection lens system 70, the occurrence of wave aberration by oscillation scanning of the galvano mirrors 44 and 45 can be suppressed. Consequently, according to the invention a high image formation capability can be maintained with a wide field of view without disturbing collected shapes or condensing shapes of the erase light which influences the super-resolving microscope performance, while the pump light and erase light can be always collected on the sample 63 to be observed in the positional relationship as shown in FIG. 4 so that the super-resolving performance can be realized in excellent conditions.

### Second Embodiment

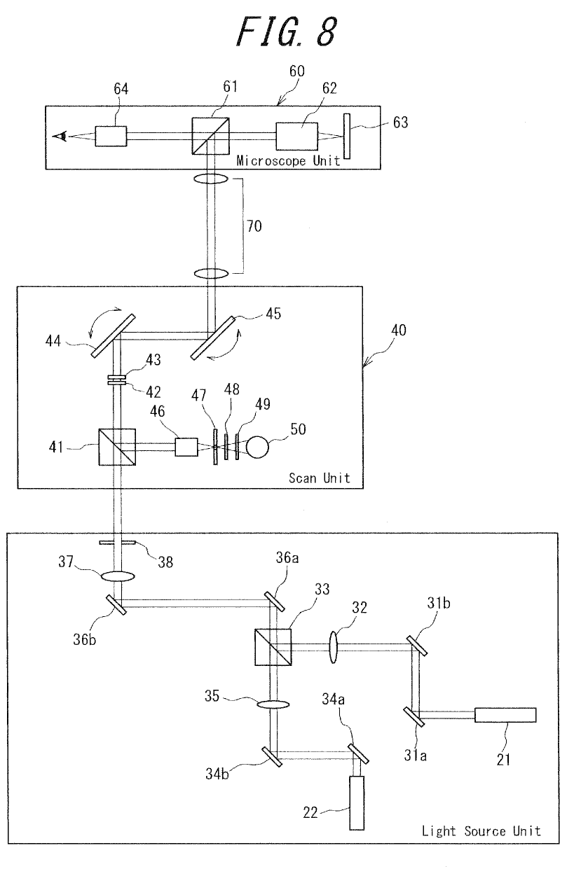

FIG. 8 is a block diagram of main parts of the optical system of the super-resolving microscope according to the second embodiment. This super-resolving microscope is different in the constitution of the light source unit 20 from the super-resolving microscope shown in FIG. 7.

In other word, according to the present embodiment, the pump light and the erase light are coaxially combined without using any optical fiber and thereafter the erase light is modulated in phase. For this purpose, the pump light emitted from the pump light source 21 is conducted to angle adjusting mirrors 31a and 31b where the angles of the pump light in two dimensional directions are adjusted, and further conducted to a beam divergent angle-adjusting lens 32 where divergent angles of the pump light are adjusted. Thereafter, the pump light is caused to be incident to dichroic prisms 33. Similarly, the erase light emitted from the erase light source 22 is conducted to angle adjusting mirrors 34a and 34b where the angles of the erase light in two-dimensional directions are adjusted, and further conducted to a beam divergent angle-adjusting lens 35 where divergent angles of the erase light are adjusted. Thereafter, the erase light is caused to be incident to the dichroic prisms 33 where the erase light is adjusted into coaxial relation to the pump light, and the coaxial pump and erase lights are then emitted therefrom.

The pump light and the erase light coaxially emitted from the dichroic prisms 33 are adjusted in angle in two dimensional directions by angle adjusting mirrors 36a and 36b and further adjusted in divergent angles by a beam divergent angle adjusting lens 37, and thereafter the pump light and the erase light are induced through an iris 38 into the scan unit 40. The other constructions are substantially the same as those of the first embodiment.

According to the present embodiment, it is required to coaxially adjust the pump light and the erase light by means of the angle adjusting mirrors 31a, 31b, 34a and 34b. However, after the coaxial adjustment, as the pump light and the erase light are induced to the wavelength selecting element 42 and the space modulating element 43 where the phase modulation of the erase light is performed, the pump light and the erase light are affected by exactly the same divergence and angular misalignment by means of the wavelength selecting element 42 and the space modulating element 43. Therefore, the present embodiment provides the same effects as those of the first embodiment.

### Third Embodiment

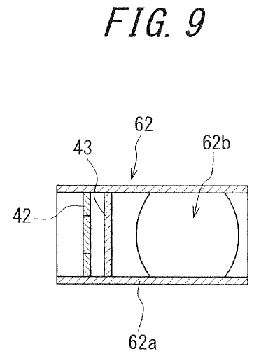

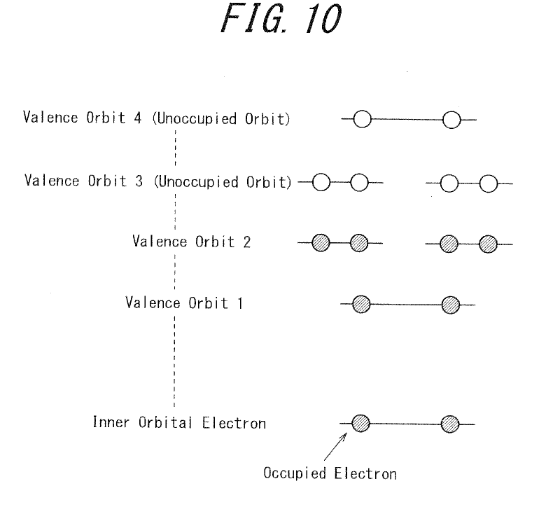

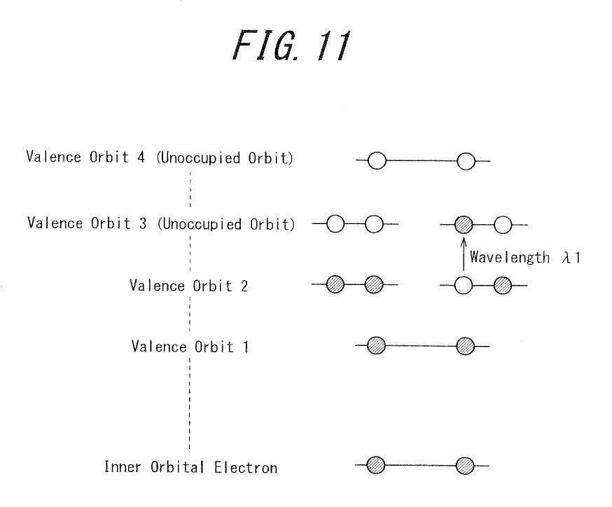

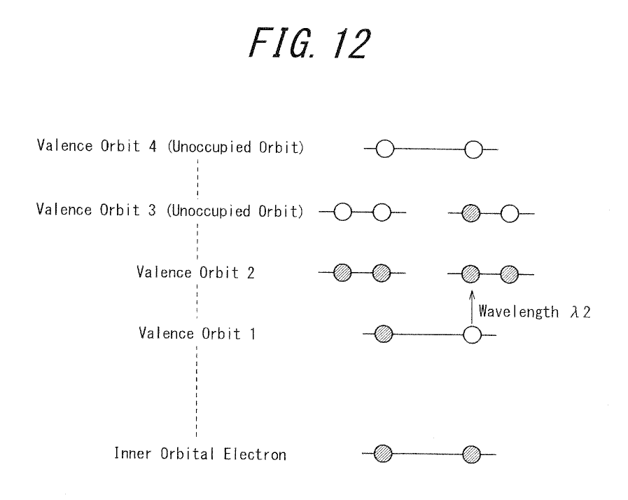

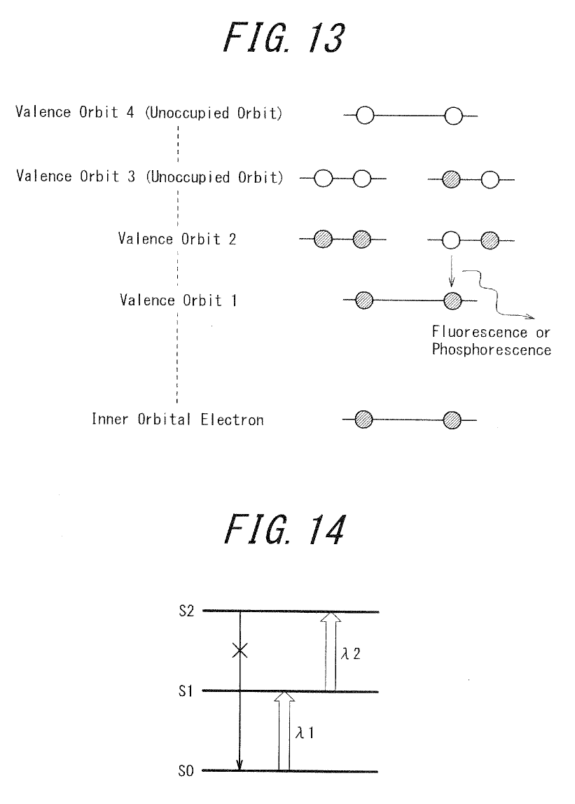

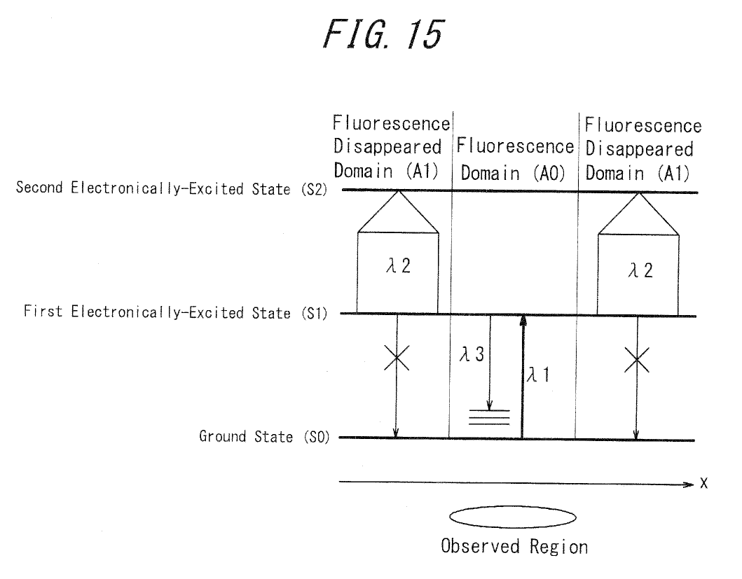

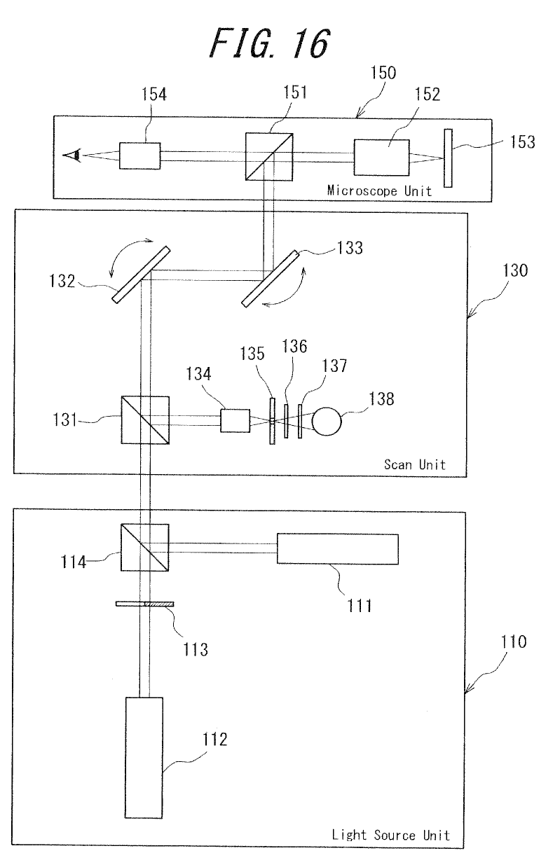

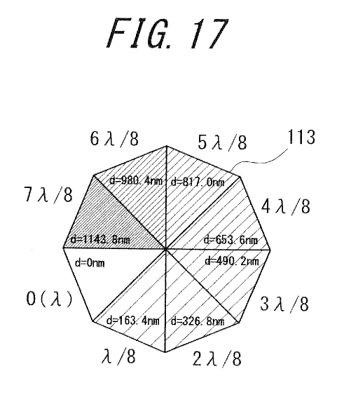

FIG. 9 is a cross-sectional view of a substantial part of the optical system of the super-resolving microscope according to the third embodiment. The configuration of the present embodiment lies in a wavelength selecting element 42 and a space-modulating element 43 arranged in a lens barrel 62a of a microscope objective lens 62 in the configuration of the first or second embodiment.

In more detail, in the lens barrel 62a of the microscope objective lens 62 the wavelength selecting element 42 and the space-modulating element 43 are arranged on the side of image of the microscope objective lens system 62b (on the incident side). Moreover, the galvano mirrors 44 and 45 are arranged so as to be located on both sides of the conjugate pupil surface of the microscope objective lens 62 projected by the pupil projection lens system 70 (this arrangement is not shown).

According to the present embodiment, in the same manner of the embodiments described above, a high image formation capability with a wide field of view can be maintained, while the pump light and the erase light can be collected on the sample 63 to be observed always in the positional relationship as shown in FIG. 4, thereby realizing the super-resolving performance in good conditions. Moreover, as the wavelength selecting element 42 and the space modulating element 43 are arranged in the lens barrel 62a of the microscope objective lens 62 on the side of image of the microscope objective lens system 62b (on the incident side), the microscope has an advantage enabling it to be constructed in a simpler manner.

Further, the invention is not to be limited to the embodiments described above, and various changes and modification can be made in the invention. For example, although the pump light and the erase light are deflected by the galvano mirrors 44 and 45 to scan the sample 63 two-dimensionally in the above embodiments, the sample 63 to be observed may be scanned two-dimensionally by the pump light and the erase light by moving a microscope objective lens 62 and/or a sample stage having the sample to be observed arranged thereon, or a sample 63 to be observed may be scanned two-dimensionally by a combination of one dimensional movement (main scanning) of the pump light and the erase light with one galvano mirror and one dimensional movement (auxiliary scanning) of a microscope objective lens 62 or a sample stage in a direction perpendicular to the first mentioned one dimensional movement.

Moreover, the wavelength selecting element 42 and the space modulating element 43 may be arranged in a pupil position of the microscope objective lens 62 or in the proximity thereof in the lens barrel of the microscope objective lens 62. In the case that the pump light and the erase light are deflected for scanning a sample 63 to be observed, it is preferable to arrange the wavelength selecting element 42 and the space modulating element 43 in the pupil position of the microscope objective lens 62 or in the proximity thereof or in a conjugate position of the pupil position or in the proximity thereof. However, if the measurement is in the normal scanning range, the wavelength selecting element 42 and the space modulating element 43 may be jointed or spaced from each other and arranged in an arbitrary position in light paths or preferably parallel light paths of the combined pump and erase lights, thereby enabling a super-resolving performance to be realized in good conditions.

Moreover, the wavelength selecting element 42 is not to be limited to such an arrangement that the erase light and pump light selected regions are formed to be concentric circular. Regions of the erase light and the pump light may be formed so as to include three regions in the cross-section of optical axis, that is, an erase light region of only intensity of erase light a pump light region of only intensity of pump light, and a overlapping region located at the border between the erase light region and the pump light region, which is smaller in area than the erase light region and the pump light region and has low intensities of the erase light and pump light.

### INDUSTRIAL APPLICABILITY

According to the invention, after the pump light and the erase light have been combined, these lights are induced into the wavelength selecting element and the space modulating element so that the pump light and the erase light can be collected or condensed exactly onto the same image location on a sample to be observed by light collecting means without requiring troublesome optical adjustments, thereby enabling a super-resolving effect to be realized.

1. A microscope for observing a sample containing a substance having at least two excited quantum states, said microscope comprising:
a pump light source for emitting pump light for exciting said substance from its ground state to a first excited state,
an erase light source for emitting erase light for making said substance transit from said first excited state to another excited state,
light combining means for coaxially combining said pump light and said erase light,
light collecting means for collecting the combined lights combined by said light combining means onto said sample,
scanning means for scanning said sample with said combined lights by relatively moving said sample and said combined lights collected by said light collecting means,
detecting means for detecting photoresponsive signals generated from said sample by irradiating with said combined lights,
a wavelength selecting element arranged in a light path of said combined lights, said wavelength selecting element including an erase light selecting region having a high wavelength selectivity for said erase light and a pump light selecting region having a high wavelength selectivity for said pump light, and a space modulating element arranged in the light path of said combined lights for spatially modulating the erase light corresponding to said erase light selecting region of said wavelength selecting element.

2. The microscope as claimed in claim 1, wherein said wavelength selecting element comprises a spectral transmission filter having an erase light selecting region of a high transmittance for said erase light and a pump light selecting region of a high transmittance for said pump light.

3. The microscope as claimed in claim 1, wherein said wavelength selecting element comprises a reflecting mirror having an erase light selecting region made of multilayer films of a high reflectance factor for said erase light and a pump light selecting region made of multilayer films of a high reflectance factor for said pump light.

4. The microscope as claimed in claim 1, wherein said wavelength selecting element comprises a diffraction grating having an erase light selecting region of a high diffraction efficiency for said erase light and a pump light selecting region of a high diffraction efficiency for said pump light.

5. The microscope as claimed in claim 2, wherein said wavelength selecting element is so formed that said combined lights passed through said wavelength selecting element have in the cross-section of optical axis an erase light region where only an intensity of said erase light exists, a pump light region where only an intensity of said pump light exists, and an overlapping region located at the border between said erase light region and said pump light region, said overlapping region being smaller than the contour of said combined lights in the cross-section of the optical axis and having a low overlapping intensity of said erase light and said pump light.

6. The microscope as claimed in claim 3, wherein said wavelength selecting element is so formed that said combined lights passed through said wavelength selecting element have in the cross-section perpendicular to optical axis an erase light region where only an intensity of said erase light exists, a pump light region where only an intensity of said pump light exists, and an overlapping region located at the border between said erase light region and said pump light region, said overlapping region being smaller than the contour of said combined lights in the cross-section perpendicular to the optical axis and having a low overlapping intensity of said erase light and said pump light.

7. The microscope as claimed in claim 1, wherein said wavelength selecting element has said erase light selecting region and said pump light selecting region divided in the form of concentric circles.

8. The microscope as claimed in claim 2, wherein said wavelength selecting element has said erase light selecting region and said pump light selecting region divided in the form of concentric circles.

9. The microscope as claimed in claim 3, wherein said wavelength selecting element has said erase light selecting region and said pump light selecting region divided in the form of concentric circles.

10. The microscope as claimed in claim 7 wherein said pump light selecting region of said wavelength selecting element occupies a circular region in the proximity of the optical axis, and said erase light selecting region of said wavelength selecting element occupies an annular zone region on the outer side of said pump light selecting region.

11. The microscope as claimed in claim 8 wherein said pump light selecting region of said wavelength selecting element occupies a circular region in the proximity of the optical axis, and said erase light selecting region of said wavelength selecting element occupies an annular zone region on the outer side of said pump light selecting region.

12. The microscope as claimed in claim 9 wherein said pump light selecting region of said wavelength selecting element occupies a circular region in the proximity of the optical axis, and said erase light selecting region of said wavelength selecting element occupies an annular zone region on the outer side of said pump light selecting region.

13. The microscope as claimed in claim 10, wherein the diameter of said pump light selecting region of said wavelength selecting element is smaller than the diameter of an incident aperture of said light collecting means, and the outer diameter of said erase light selecting region of said wavelength selecting element is larger than the diameter of the incident aperture of said light collecting means.

14. The microscope as claimed in claim 11, wherein the diameter of said pump light selecting region of said wavelength selecting element is smaller than the diameter of an incident aperture of said light collecting means, and the outer diameter of said erase light selecting region of said wavelength selecting element is larger than the diameter of the incident aperture of said light collecting means.

15. The microscope as claimed in claim 12, wherein the diameter of said pump light selecting region of said wavelength selecting element is smaller than the diameter of an incident aperture of said light collecting means, and the outer diameter of said erase light selecting region of said wavelength selecting element is larger than the diameter of the incident aperture of said light collecting means.

16. The microscope as claimed in claim 10, wherein said space modulating element comprises a phase plate having a substrate transparent to said pump light and said erase light, said phase plate having an etched region for phase-modulating the erase light corresponding to said erase light selecting region of said wavelength selecting element.

17. The microscope as claimed in claim 11, wherein said space modulating element comprises a phase plate having a substrate transparent to said pump light and said erase light, said phase plate having an etched region for phase-modulating the erase light corresponding to said erase light selecting region of said wavelength selecting element.

18. The microscope as claimed in claim 12, wherein said space modulating element comprises a phase plate having a substrate transparent to said pump light and said erase light, said phase plate having an etched region for phase-modulating the erase light corresponding to said erase light selecting region of said wavelength selecting element.

19. The microscope as claimed in claim 10, wherein said space modulating element comprises a phase plate having a substrate transparent to said pump light and said erase light, said phase plate being coated with an optical film for phase-modulating the erase light corresponding to said erase light selecting region of said wavelength selecting element.

20. The microscope as claimed in claim 11, wherein said space modulating element comprises a phase plate having a substrate transparent to said pump light and said erase light, said phase plate being coated with an optical film for phase-modulating the erase light corresponding to said erase light selecting region of said wavelength selecting element.

21. The microscope as claimed in claim 12, wherein said space modulating element comprises a phase plate having a substrate transparent to said pump light and said erase light, said phase plate being coated with an optical film for phase-modulating the erase light corresponding to said erase light selecting region of said wavelength selecting element.

22. The microscope as claimed in claim 1, wherein said wavelength selecting element and/or said space modulating element is provided in the lens barrel of said light collecting means.

23. The microscope as claimed in claim 1, wherein said wavelength selecting element and/or said space modulating element is provided in a pupil surface, or a conjugate pupil surface of said light collecting means, or in the proximity thereof.
